(19) United States
(12) Patent Application Publication
(10) Pub. No.: US 2026/0284453 A1
(43) Pub. Date: Sep. 24, 2026

(54) AUTOMATIC FIRE EXTINGUISHING SYSTEM FOR PARKING SPACES FOR ELECTRIC VEHICLES

(71) Applicant: Davide ZANON, Bremgarten (CH)

(72) Inventor: Davide ZANON, Bremgarten (CH)

(21) Appl. No.: 18/998,029

(22) PCT Filed: Aug. 8, 2023
(86) PCT No.: PCT/IB2023/057999

§ 371 Date: Jan. 23, 2025

(30) Foreign Application Priority Data
Sep. 2, 2022 (CH) CH001026/2022

(51) Int. Cl. A62C 3/07; A62C 31/02; A62C 37/44

(52) U.S. Cl. CPC A62C 3/07; A62C 31/02; A62C 37/44

(57) ABSTRACT

An automatic fire extinguishing system for extinguishing fires from electric vehicles has fire detectors having at least one temperature sensor and/or smoke sensor which are connected to a central fire alarm system, wherein the fire detectors are fixedly installed on the floor of parking spaces for electric vehicles. The central fire alarm system is designed to automatically actuate a system for generating high-pressure water spray. High-pressure water spray is guided via a main pipeline to central, lateral and/or vertical pipelines at the parking spaces. The central fire alarm system actuates solenoid valves in the pipelines such that high-pressure water spray is conducted to and discharged at only those parking spaces where a fire alarm has been triggered by a fire detector. The fire extinguishing system allows early detection of overheated or burning electric vehicles and targeted cooling or extinguishing of the electric vehicles with a limited quantity of water.

### TECHNICAL FIELD

The invention relates to an automatic fire extinguishing system, in particular for garages for electric cars.

### DESCRIPTION OF RELATED ART

According to the Federal Statistical Office, the share of electric vehicles on Swiss roads is currently around 1.5% of the total number of road vehicles. If vehicles with hybrid drives (combustion engine plus electric motor) are included, the figure is 6%. It is likely that this share will increase. It is well known that fires in electric cars differ greatly from car fires with combustion engines. In particular, fires that start in the batteries of electric cars can develop explosively and spread rapidly due to the so-called thermal runaway effect. Another particular hazard is that the chemical reactions in overheated batteries release oxygen, which further fuels a fire.

Today, fire protection systems installed in parking garages are typically equipped with sprinkler systems that are activated by the heat of an incipient fire. These systems are generally designed to extinguish fires in cars with combustion engines, as they are only triggered several minutes after the fire has broken out and can only partially prevent the explosive development of fires of battery fires. To date, there are no automatic fire protection systems on the market that are specifically designed for electric cars.

However, fire protection systems for extinguishing fires in electric cars are known from patent literature. For example, CN 215537956U discloses a system for extinguishing fires in an electric charging station, which is equipped with flame detectors on the garage ceilings and a water drop sprinkler system. A high-pressure water pump is used to distribute a large amount of water over the surface of the sprinkler system via nozzles on vertical columns. The system has a water tank that is refilled from the local water supply as needed. The large amount of water is intended to cool the burning cars and extinguish the fire.

Another system, as disclosed in CN112370703, has a sensor at the bottom of a parking space that can detect the presence of a vehicle, smoke and flame sensors, and temperature sensors to detect the temperature at the underbody of the vehicle. If the temperature measured exceeds a certain threshold, a visual or audible alarm is triggered to summon personnel to check the vehicle. If smoke or flames are detected, sprinkler systems are activated, directing a mixture of water and air onto the vehicle via a pipe system.

WO 2021175391 discloses a movable fire extinguishing device for vehicles. It consists of pipelines and a multitude of nozzles for extinguishing water. The device is placed under and to the side of a car in case of fire. Preferably, the pipes with the nozzles are arranged on a movable frame so that in case of a fire alarm, the pipe system can be pushed or driven towards the burning car. Neither a fire detection method nor a connection to a source of extinguishing water is disclosed.

### SUMMARY OF THE INVENTION

The present invention is based on the realization that known sprinkler systems are too slow in view of the rapid development of fires in electric vehicles and that the water sprayed down from the ceilings by the sprinkler systems cannot sufficiently cool the batteries in the floor of the electric cars. The object of invention is therefore to create an improved fire extinguishing system for electric vehicles that avoids this disadvantage.

An automatic system for extinguishing fires in electric vehicles, according to the present invention, comprises the following components:
one or more fire detectors, each of which can be permanently installed on the floor of a parking space for electric vehicles and has at least one temperature sensor and/or at least one smoke sensor,
a central fire alarm unit connected to each of the one or more fire detectors,
a system for generating a high-pressure water mist, to which a main pipeline for the high-pressure water mist is connected, the main pipeline being configured to lead to the one or more parking spaces,
one or more pipelines that are connected to the main pipeline at the one or more parking spaces and can be attached to the floor of the one or more parking spaces,
nozzles for discharging the high-pressure water mist, wherein nozzles are arranged on the pipelines and being orientable upwards, i.e., in the direction of the underbody of an electric vehicle parked in the parking space,
wherein the central fire alarm unit is configured to activate the system for generating high-pressure water mist and to initiate the supply of high-pressure water mist into the main pipeline and the pipelines in the event of an alarm due to a signal from the at least one temperature sensor and/or the at least one smoke sensor in the one or more fire detectors.

The invention has the advantage that the fire detectors at the floor of each parking space can detect an increase in temperature of an electric vehicle battery located there or smoke escaping from the floor of the car at an early stage, thus detecting the development of heating and the possible development of a battery fire at the earliest possible stage and allowing timely, early cooling of the battery to be initiated. This means that the outbreak of a fire can be avoided or a fire can be extinguished at an early stage. By connecting the fire detectors to the central fire alarm unit, the central fire alarm unit can automatically control the system for generating and directing high-pressure water mist and simultaneously alert the fire department based on an electrical signal from the fire detectors. The signal from the temperature sensors integrated in the fire detectors can be sent to the central fire alarm unit either because a predetermined temperature value has been exceeded or because a predetermined temperature increase has been reached. This means that an action can be triggered as soon as there is an excessive increase in the temperature of a battery. High-pressure water mist can be directed both quickly and specifically into the underbody area where the electric vehicle battery is located, and can cool the battery effectively. This can prevent the thermal runaway effect from spreading in the battery and already stop a fire from breaking out.

To cool the underbody of an electric vehicle parked in a parking space, the nozzles for applying high-pressure water mist are directed upwards. This means that high-pressure water mist is sprayed vertically upwards from the nozzles and at an angle with respect to the vertical direction onto the underbody of the electric car. The angle range, the number of nozzles and the distances between the nozzles are coordinated so that the high-pressure water mist that is applied reaches as much of the vehicle's underbody as possible.

The use of high-pressure water mist in particular enables overheated batteries to be cooled and fires to be extinguished in a short time. In addition, the use of high-pressure water mist makes it possible to contain fires with a small amount of water. This means that the extinguishing system according to the invention can be installed in existing parking garages without the need for an additional water supply system, as would be necessary with known systems. Instead, the system according to the invention can be realized with a water tank of limited size. The realization of the system is therefore also correspondingly cost-effective.

The arrangement and/or attachment of the fire detectors on the floor of parking spaces and the arrangement and/or attachment of the pipelines for the high pressure water mist also on the floor of the parking spaces does not require any significant structural changes to the parking garage. An existing garage can be easily and inexpensively retrofitted with the system according to the invention. In this context, the attachment of the pipelines to the floor of a parking space is to be understood as including an attachment of the pipelines to the surface of the floor, i.e., an attachment both on the surface and under the surface of the floor. When attaching the pipelines under the surface of the floor, the pipelines can be placed slightly recessed in the floor.

In an embodiment of the invention, the automatic fire extinguishing system has first central pipelines with nozzles that are connected to the main pipline and can be arranged on the floor of each parking space and in particular in the longitudinal direction along the center of the parking space, so that they can extend under and along the center of a vehicle located there. The nozzles are configured to discharge high-pressure water mist upwards at an angle with respect to the vertical direction. The underbody of a vehicle is cooled or extinguished by discharging high-pressure water mist through these nozzles.

In an embodiment of the invention, the automatic fire extinguishing system has lateral pipelines with nozzles that are connected to the main pipeline and can be arranged on the floor and sides of each parking space in a longitudinal direction, so that they can extend along the sides of a vehicle located there. The nozzles are configured to spray high-pressure water mist at an angle ranging from horizontal, i.e., along the floor, to a predetermined angle upwards. The high-pressure water mist is sprayed from these nozzles under the vehicle, onto the floor of the vehicle and onto the sides of the vehicle. These lateral pipelines and nozzles serve to cool the electric vehicle on the sides as well and, in particular, to prevent heat or fire from spreading to a vehicle standing next to it.

Preferably, the system according to the invention has pipelines that can be arranged both centrally along the longitudinal direction and laterally along the longitudinal direction of the parking spaces.

In a further embodiment of the invention, the system for directing high-pressure water mist has vertical pipes that are arranged in the area of the corners of each parking space and extend upwards from the floor. The pipes have nozzles that are configured to discharge high-pressure water mist along the sides of the parking space and within a predetermined angular range.

The arrangement of the nozzles on the vertical pipelines also makes it possible to discharge high-pressure water mist along the sides of an overheated or burning vehicle, thus preventing the fire from spreading to a neighboring vehicle.

In a further embodiment of the invention, the system for directing high-pressure water mist has further pipes that can be arranged on the floor of the parking space and are connected to the main pipeline and extend parallel to the short side of the parking space. They have nozzles that are configured to spray high-pressure water mist in a horizontal direction and upwards within a predetermined angle range.

These nozzles make it possible to spray high-pressure water mist onto the underbody of a vehicle parked there.

Preferably, the system according to the invention comprises both vertical pipes and the further pipes along the short side of the parking space.

In an embodiment of the invention, the pipelines for conducting high-pressure water mist, which are connected to the main pipeline for high-pressure water mist, are each equipped with solenoid valves, wherein the solenoid valves are connected to the central fire alarm system and are controlled by it. This makes it possible to open the solenoid valves of the pipelines only in the parking space where an alarm has been detected due to an increase in temperature and/or the appearance of smoke. This means that cooling or extinguishing is only carried out in the specific parking space with a vehicle with a defective or burning battery. By cooling and extinguishing only in one or a few parking spaces where a fire has occurred or is breaking out, the amount of water required to operate the extinguishing system is further reduced.

In a further embodiment of the invention, the system for generating high-pressure water mist has one or more water tanks as a water reservoir, as well as an electric high-pressure water pump. The electric high-pressure water pump is connected to the main pipeline for the delivery of high-pressure water mist. This system can also generate sufficient high-pressure water mist with a limited amount of water, so that no additional water supply needs to be provided. However, this system requires an electrical connection to the emergency power supply, which can be ensured, for example, by batteries.

In a further embodiment of the invention, the high pressure water mist generation system comprises again one or more water tanks as water reservoirs and a high pressure water pump, which can be driven by an internal combustion engine and which is connected to the main pipeline for conducting high pressure water mist.

In a further embodiment of the invention, the system for generating high-pressure water mist has one or more non-pressure-resistant water tanks as a water reservoir, at least two pressure-resistant water tanks and one or more gas cylinders for gas, for example nitrogen. The pressure-resistant water tanks are connected on the one hand to a gas cylinder and on the other hand to the non-pressure-resistant water tank as a water reservoir. In addition, a pipe leads from each of the pressure-resistant water tanks to the main pipeline for the supply of the high-pressure water mist. This system for generating high-pressure water mist allows water to be fed from the water reservoir into the pressure-resistant water tanks. Using nitrogen or another suitable gas from the gas cylinders and by opening a valve on the first of at least two pressure-resistant water tanks, high-pressure water mist is fed into the main pipeline of the pipe system. If the first pressure-resistant water tank is empty, the valve of this first tank is closed and the valve on the second pressure-resistant water tank is opened. In this way, high-pressure water mist is fed from the second pressure-resistant water tank into the main pipeline for the high-pressure water mist by means of gas from the gas cylinders. While the second pressure-resistant water tank is emptying, the first pressure-resistant water tank is refilled with water from the water reservoir. When the second pressure-resistant water tank is empty, the valve on the first pressure-resistant water tank for high-pressure water mist is opened again.

A fire extinguishing system according to the invention with this type of system for generating high-pressure water mist is particularly cost-effective in that only two relatively small pressure-resistant water tanks are required. Pressure-resistant water tanks are very expensive compared to conventional water tanks. Therefore, the manufacturing costs of a system of this type are kept within limits thanks to the small number and small size of the pressure-resistant water tanks. The concept of filling the pressure-resistant water tanks in turn, however, allows for the continuous generation of high-pressure water mist. The water tank for filling the pressure-resistant water tanks is dimensioned to ensure the generation of high-pressure water mist for 30 minutes, which corresponds to the intervention time of the fire brigade. The water tank as a water reservoir must therefore be designed to hold only 1500 liters, for example. A separate water supply is therefore not necessary, which in turn makes it easier to retrofit a parking garage with this system. Furthermore, the operation of this system does not require any additional emergency power supply.

In a further embodiment of the invention, the system for generating high-pressure water mist has one or more water tanks as a water reservoir, in addition to a pneumatic pump and one or more gas cylinders for compressed air. The pneumatic pump is connected to the main pipeline for the high-pressure water mist. The advantage of this system is that it can generate high-pressure water mist with a limited amount of water during the intervention period until a fire brigade arrives on the scene. In Switzerland, this period is less than 30 minutes. An additional water supply is not necessary for the operation of the system according to the invention. Furthermore, the operation of this system does not require an additional emergency power supply.

The system according to the invention is suitable for parking garages or parking lots for vehicles, in particular electric vehicles, whereby the parking lots or parking garages can be of any size with any number of parking lots. The size of the parking lots can also be as large as required, i.e. they can be dimensioned for vehicles for private transport as well as for buses or other larger vehicles. The system according to the invention can easily be scaled due to its design. On the one hand, it can be designed for parking spaces for vehicles for two to six people, for example, with the appropriate design of the nozzles, and on the other hand, it can also be designed for parking spaces up to 12 m long, such as for buses or coaches or trucks.

Further advantages of the invention are derived from the dependent claims and the following description, in which the invention is explained in more detail with reference to an example shown in the schematic drawings. It shows:

### BRIEF DESCRIPTION OF THE DRAWINGS

It is shown in

FIG. 1 a schematic representation of the system for automatically extinguishing fires in electric vehicles in a parking garage in accordance with the invention, with fire detectors on the floor of each parking space, a central fire alarm unit, a system for generating high-pressure water mist, a main pipeline and central and lateral pipelines with nozzles,

FIG. 2 a schematic representation of the system for automatically extinguishing fires in electric vehicles according to the invention, whereby the system for generating high-pressure water mist has a non-pressure-resistant water tank, several gas cylinders and two pressure-resistant water tanks,

FIG. 3 a schematic detailed representation of the system for generating high-pressure water mist according to FIG. 2.

FIG. 4 the system of FIG. 3 with an illustration during operation,

FIG. 5 a view of a single parking space with fire detectors according to the system of the invention and pipelines with nozzles for high-pressure water mist attached to the floor of the parking spaces,

FIG. 6 a view of a single parking space with fire detectors according to the system according to the invention and with vertical pipelines with nozzles for the output of high-pressure water mist according to the system according to the invention.

FIG. 7 a view of a single parking space with the extinguishing system according to the invention as in FIG. 6 and additional pipelines with nozzles for high-pressure water mist parallel to the short side of the parking space.

The same reference numbers have been used for the same elements in each of the figures, and initial explanations apply to all figures unless otherwise stated.

### DETAILED DESCRIPTION

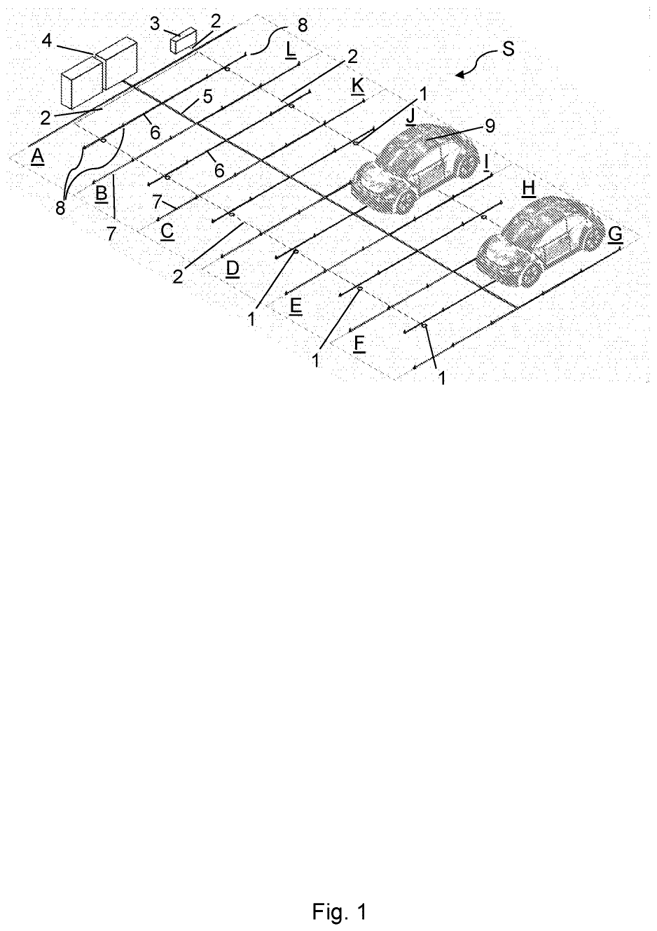

FIG. 1 shows the basic principle of the automatic fire extinguishing system S for electric vehicles according to the invention, as well as its essential features. The entire system S is arranged in a stationary manner in a parking lot for one or more electric vehicles. As an example, a parking space with 12 parking spaces A-L for electric passenger cars is shown here. The system can be installed next to the parking space in a space-saving manner. A fire detector 1 with at least one temperature sensor is installed on the floor at each parking space A-L, whereby the fire detectors are connected to a central fire alarm unit via an electrical signal line 2. The fire detectors are preferably placed in the center of each parking space so that they are as close as possible to the battery of an electric vehicle parked there. A tank 4 for extinguishing water and a system 4 for generating high-pressure water mist connected to the tank are located next to the parking spaces. System 4 can be a system with a non-pressurized water tank, 2 pressurized water tanks and gas cylinders. It can also be a system with a water tank and a pneumatic high-pressure pump or a system with a water tank and an electric high-pressure pump. A main pipeline 5 for the high-pressure water mist leads from system 4 to the individual parking spaces A-L, with one or more pipelines 6, 7 branching off from the main pipeline 5 at each parking space. These serve to direct the high-pressure water mist to different parts of each parking space. The pipelines 6, 7 are arranged on the floor of the parking space and extend the length of each parking space. The first pipelines 6 run through the center of each parking space along its length. Second pipelines 7 run along the sides of each parking space, also along the longitudinal direction. The pipelines 6, 7 have several nozzles 8 for discharging the high-pressure water mist. The nozzles 8 are designed and aligned so that high-pressure water mist is directed from the floor up to the underbody of an electric vehicle 9. The nozzles on the laterally arranged pipelines 7 are also aligned so that the high-pressure water mist is directed both at the underbody of the electric vehicle and at the sides of the electric vehicle 9.

When an electric vehicle 9 is parked in a parking space with a fire extinguishing system according to the present invention, its floor and battery are located near the fire detector 1 of the respective parking space. If the battery overheats due to a defect or overcharging, the temperature and/or temperature increase of the underside of the electric vehicle 9 and/or smoke escaping from the battery is detected by the fire detector 1. If the temperature or temperature increase or the amount of smoke exceeds a predetermined threshold, an electrical signal is sent via the signal line 2 to the central fire alarm unit 3. This then triggers the activation of system 4 for generating high-pressure water mist, which is supplied to the affected parking space for cooling and extinguishing. The high-pressure water mist is fed into the main pipeline 5 for this purpose. The central fire alarm unit 3 also triggers the opening of valves, in particular solenoid valves, which are located at branches of the main pipeline 5 where pipelines 6 and 7 lead away from the main pipeline. The activation of the valves by the fire alarm center, based on the information from a specific fire detector 1, ensures that high-pressure water mist is only supplied to the parking space where a fire detector has detected an excessive temperature increase or an excessive temperature or smoke particles.

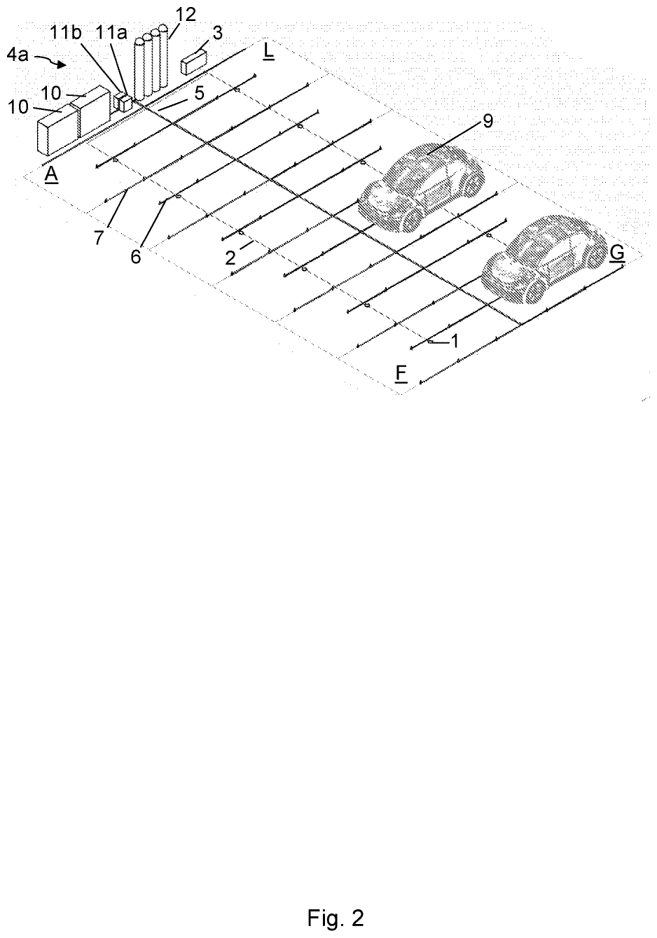

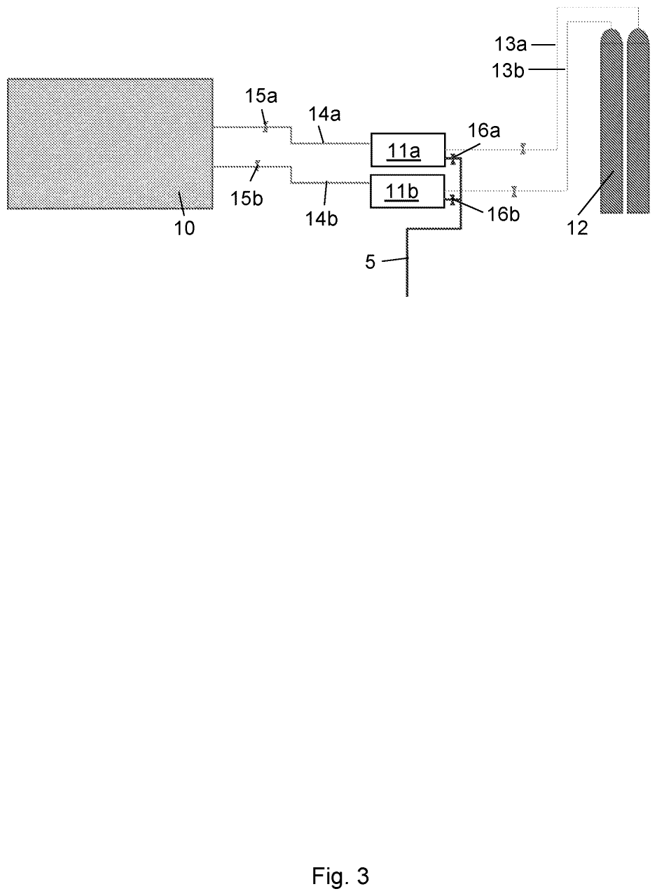

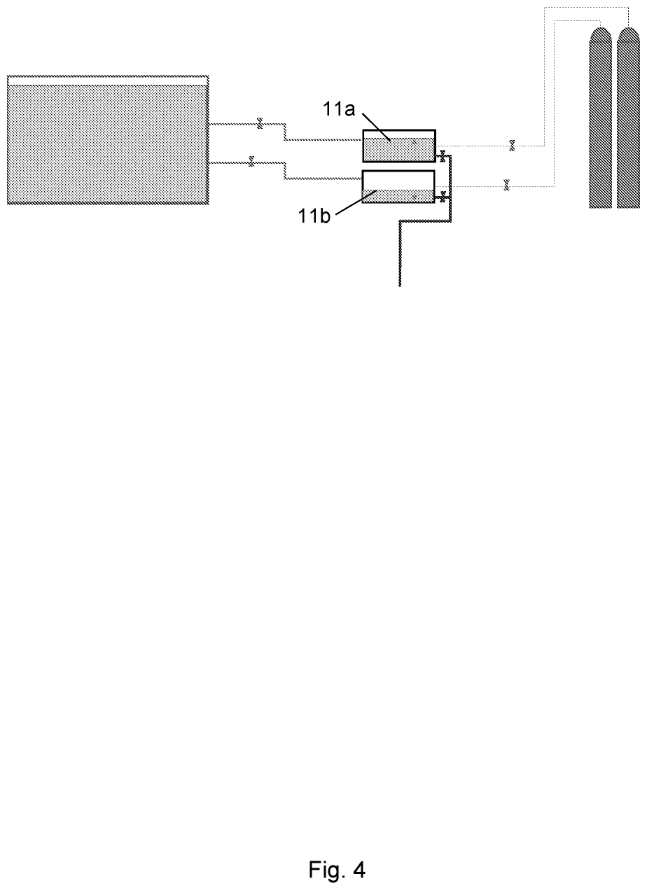

FIG. 2 shows the system S according to the invention, with a preferred embodiment of system 4 for generating the high-pressure water mist. This system 4a has water tanks 10 that are not pressure-resistant, for example made of plastic, as well as at least two pressure-resistant water tanks 11a and 11b and gas cylinders 12 with nitrogen or another gas. These components enable the continuous generation of high-pressure water mist for a period of time until a fire brigade can arrive on the scene. This period of time is, for example, 30 minutes, which corresponds to the intervention time of the fire brigade. The high-pressure water mist generated during this time can be generated with a limited amount of water, so that a water reservoir in the form of a water tank of limited size is sufficient. This amount is, for example, 1500 liters. The water tank required for this can be easily placed in an existing parking garage without the need for any structural measures. The pressure-resistant water tanks 11a, b required to generate the high-pressure water mist are of limited size, for example 2×20 liters, so that they are cost-effective and can be installed in a space-saving manner. The detailed structure and the functionality of the system 4a for generating the high pressure water mist are shown in FIGS. 3 and 4.

FIGS. 3 and 4 show the two pressure-resistant water tanks 11a, 11b, each of which is connected by a gas line 13a, b to two gas cylinders 12 with nitrogen. In addition, each of the two pressure-resistant water tanks 11a, b is connected to the water tank 10 via a water line 14a, b with valve 15a, b. From each of the two pressure-resistant water tanks 11a, b, a pipeline 16a, b with a valve leads away, in which the generated high-pressure water mist is directed to the main pipeline 5.

In the event of a fire being detected, the central fire alarm unit 3 activates system 4a to generate the high-pressure water mist by closing the valve in the gas line 13a and opening the valve 15a in the water line 14a. This causes water to flow into the pressure-resistant water tank 11a. As soon as the water tank 11a is full, the valve 15a is closed and the valve in the gas line 13a is opened so that the water is pressurized by the gas from the gas cylinders. In the pressure-resistant water tanks, the water is kept at 80 bar, for example. Once the pressure-resistant tank 11a is full, the first valve in the pipeline 16a for the high-pressure water mist is opened and the high-pressure water mist is fed into the main pipeline 5. As the level in the first pressure-resistant water tank 11a drops, the second valve for gas in the gas line 13b is closed and the second valve 15b in the water line 14b from water tank 10 is opened, so that the second pressure-resistant tank 11b is filled. As soon as the fill level in the first pressure-resistant tank 11a falls below a specified value, the valve 16b for high-pressure water mist from the second pressure-resistant water tank 11b is opened. The valve in the water pipe 14b and the valve 16a are then closed. This means that one water tank can be filled while the other water tank is being emptied, ensuring a constant supply of high-pressure water mist.

The advantage of system 4a is that high-pressure water mist can be generated with pressure-resistant water tanks of a limited size and thus at low cost. The limited amount of water required to operate the fire extinguishing system is sufficient, in that only those parking spaces where a fire has actually broken out are supplied with high-pressure water mist.

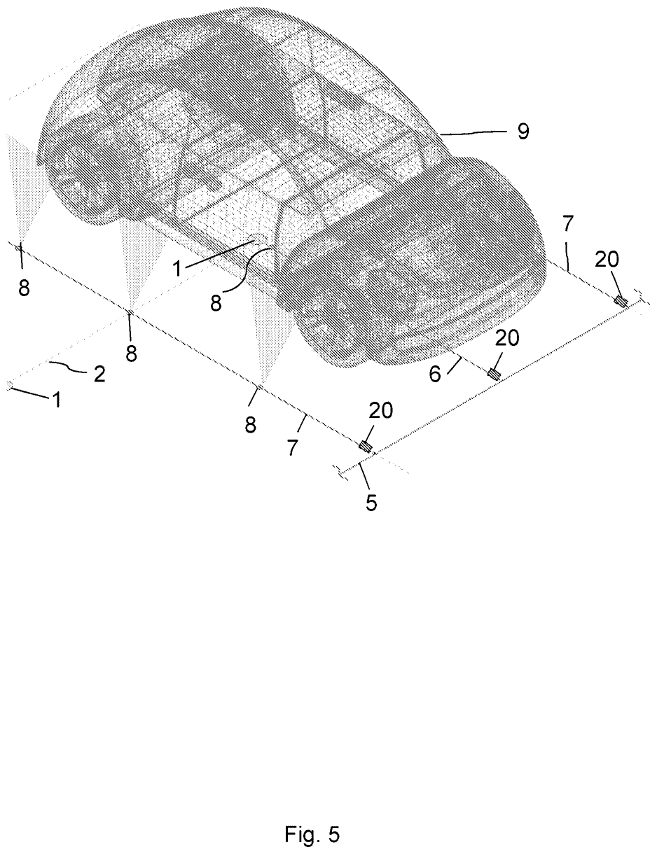

FIG. 5 shows a first embodiment of the system according to the invention, in particular an embodiment of the pipelines with nozzles for discharging the high pressure water mist within a parking space. Shown is the main pipeline 5 which supplies high pressure water mist from the high pressure pump. Pipelines 6 and 7 lead away from the main pipeline 5, with the flow of high-pressure water mist into these pipelines 6 and 7 being triggered by solenoid valves 20. The solenoid valves 20 are in turn controlled by the central fire alarm unit.

All pipelines 6 and 7 are arranged on the floor of the parking space. Pipeline 6 runs through the middle and in longitudinal direction of the parking space. At least one nozzle 8 is arranged on this pipeline 6 and aligned so that high-pressure water mist can be sprayed from the floor upwards onto the underbody and the area of the battery of an electric vehicle 9 parked there. These nozzles ensure that an overheated battery is cooled down quickly and also that a fire is extinguished if it has already broken out. The lateral pipelines 7 are installed along the sides of the parking space. The nozzles 8 attached to them are designed to spray high-pressure water mist onto the floor, along the floor, onto the underbody of the vehicle and also onto the sides of the vehicle. The lateral pipelines 7 with nozzles 8 ensure that the vehicle is cooled and extinguished on its sides, and that heat and flames are prevented from spreading to a neighboring parking space.

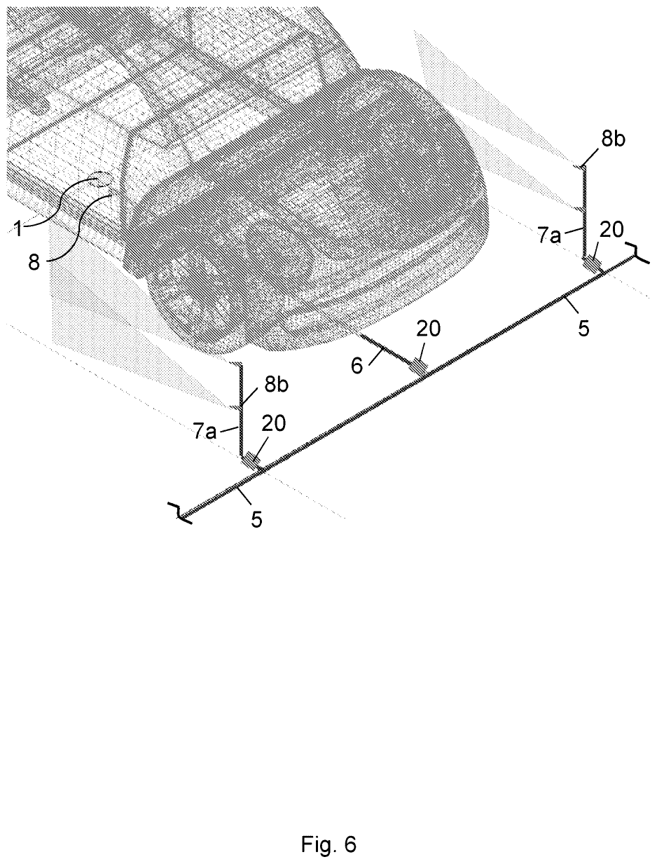

FIG. 6 shows an embodiment of the extinguishing system according to the invention with vertically arranged pipelines, wherein the vertical pipelines 7a are each connected to the main pipeline 5 and extend vertically upwards at each corner of the parking spaces. Nozzles 8b for high-pressure water mist on the vertical pipelines 7a are aligned to discharge the high-pressure water mist along the sides of the parking spaces in a predetermined angular range. The vertical pipelines 7a are in turn equipped with solenoid valves 20.

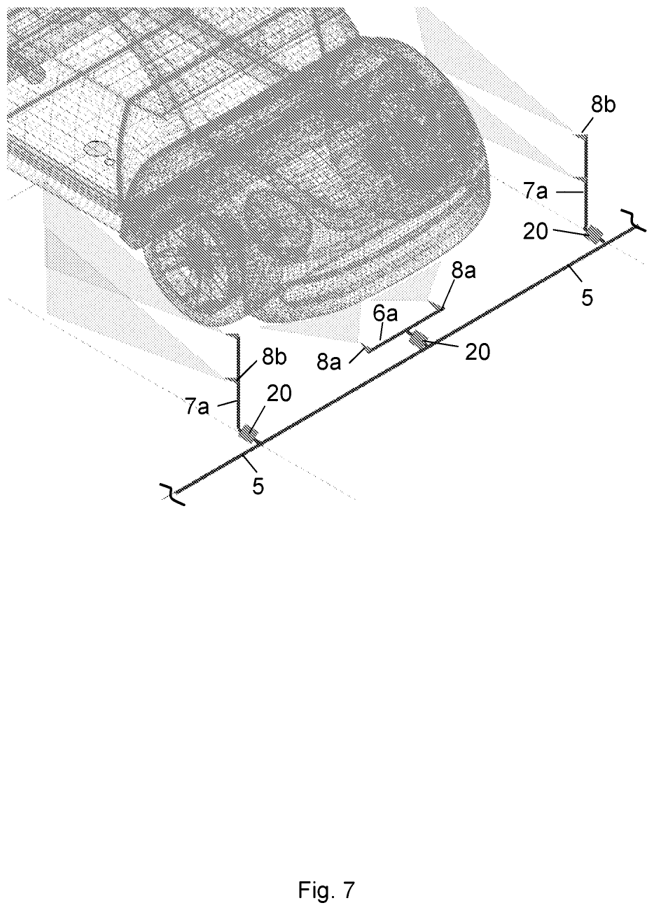

FIG. 7 shows a further embodiment of the arrangement of pipelines and nozzles for high-pressure water mist. In addition to the vertical pipelines at the corners of the parking spaces, as shown in FIG. 6, a further pipeline 6a extends from the main pipeline 5 and runs along the floor parallel to the main pipeline 5 and parallel to the short side of the parking space, and thus along the front or rear side of a vehicle parked there. Nozzles 8a on the second central pipelines 6a are directed at the underbody of the vehicle. The nozzles 8a spray high-pressure water mist, for example, at an angle of 0° to 20° relative to the plane of the floor.

Further vertical pipelines 7a lead away from the main pipeline 5 and point vertically upwards. Nozzles 8b on the vertical pipelines 7a direct high-pressure water mist in a predetermined angular range along the sides of a vehicle.

The high-pressure water mist is preferably generated by a water pressure of 80 bar, for example in a range of 40 to 80 bar. This water pressure ensures a high-pressure water mist with droplet sizes in a range of 50 to 100 micrometers. Such pressures and droplet sizes ensure a range of up to 8 meters for the high-pressure water mist.

This ensures cooling as well as extinguishing over the area of a parking space for personal electric vehicles.

In all versions, the pipelines are shown attached to the floor. As mentioned, attaching the pipelines to the floor includes both attaching them to the surface of the floor and under the surface. That is, when attached to the surface, they are arranged lying on the floor as shown in the figures. When attached under the surface, the pipelines are slightly recessed in the floor. It is practical to first mill the floor slightly to place the pipelines and then place the pipelines in them. This also applies to the nozzles associated with the pipelines, which can also be placed slightly recessed in the floor.

### List of References

1 fire detector
2 electrical signal line
3 central fire alarm unit
4, 4a system for generation of high-pressure water mist
5 main pipeline for high-pressure water mist
6 pipeline Rohrleitung in the center of a parking space
6a pipeline
7 lateral pipeline on the side of a parking space
7a vertical pipeline
8 nozzles
8a, b nozzles
9 electric vehicle
10 water tank, not pressure-resistant
11a, b pressure-resistant water tanks
12 gas cylinder
13a, b gas line with valve
14a, b water line
15a, b valve in water line
16a, b pipeline for high-pressure water mist
20 solenoid valve
A-L parking space for electric vehicles

1. An automatic system for extinguishing fires in electric vehicles, comprising
one or more fire detectors, which can each be permanently installed on a floor of one or more parking spaces for electric vehicles and has at least one temperature sensor or at least one smoke sensor,
a central fire alarm unit connected to each of the one or more fire detectors,
a system for generating a high-pressure water mist, to which a main pipeline for the high-pressure water mist is connected, the main pipeline being configured to lead to the one or more parking spaces,
one or more pipelines that are connected to the main pipeline at the one or more parking spaces and configured to be arranged on the floor of the one or more parking spaces, and
nozzles for discharging the high-pressure water mist, which are arranged on the one or more pipelines and are orientable upwards,
wherein the central fire alarm unit is configured to activate the system for generating the high-pressure water mist and to trigger a supply of the high-pressure water mist into the main pipeline and the one or more pipelines in an event of an alarm due to a signal from the at least one temperature sensor or the at least one smoke sensor in the one or more fire detectors to generate the high-pressure water mist.

2. The automatic system of claim 1, wherein the system for generating the high-pressure water mist comprises one or more water tanks as water reservoir and an electric high-pressure water pump, wherein the electric high-pressure water pump is connected to the main pipeline for conducting the high-pressure water mist.

3. The automatic system of claim 1, wherein the system for generating the high-pressure water mist comprises one or more water tanks as a water reservoir and a high-pressure water pump that can be driven by an internal combustion engine, wherein the same high-pressure water pump is connected to the main pipeline for conducting the high-pressure water mist.

4. The automatic system of claim 1, wherein the system for generating the high-pressure water mist has a non-pressure-resistant water tank, at least two pressure-resistant water tanks, which are each connected to the non-pressure-resistant water tank, and one or more gas cylinders, wherein the at least two pressure-resistant water tanks are each connected to a gas cylinder via a gas line and a line leads from each of the at least two pressure-resistant water tanks into the main pipeline for delivery of the high-pressure water mist.

5. The automatic system of claim 1, wherein the system for generating the high-pressure water mist comprises one or more water tanks as a water reservoir, a pneumatic pump and one or more gas cylinders for compressed air, wherein the pneumatic pump is connected to the main pipeline for conducting the high-pressure water mist.

6. The automatic system of claim 1, wherein central pipelines are connected to the main pipeline and disposable at a bottom of the one or more parking spaces and longitudinally along a center of the one or more parking spaces, the central pipelines having the nozzles directed upwardly.

7. The automatic system of claim 1, wherein lateral pipelines for conducting the high-pressure water mist are connected to the main pipeline for the high-pressure water mist and can be arranged on the floor of each parking space and along sides in a longitudinal direction of the one or more parking spaces, wherein the lateral pipelines comprise the nozzles for discharging the high-pressure water mist and the nozzles are configured for discharging the high-pressure water mist in an angular range from horizontal up to a predetermined angle upward.

8. The automatic system of claim 1, wherein vertical pipelines for the high-pressure water mist are connected to the main pipeline for the high-pressure water mist and are configured to be arranged in an area of corners of each parking space and extend upwards from the floor, wherein the vertical pipelines have nozzles that are configured to apply the high-pressure water mist along sides of the one or more parking spaces and in a predetermined angular range.

9. The automatic system of claim 1, wherein further pipelines for the high-pressure water mist are connected to a main piping, which are arranged parallel to a short side of a parking lot it and on the floor and comprise nozzles configured to discharge the high-pressure water mist in a horizontal direction and upwards within a predetermined angular range.

10. The automatic system of claim 1, wherein solenoid valves are arranged in each of the central pipelines, lateral pipelines, vertical pipelines and further pipelines which are connected to the main pipeline the high-pressure water mist, wherein the solenoid valves are connected to the central fire alarm unit and are controlled by the central fire alarm unit.

11. The automatic system of claim 1, wherein the pipelines are fixable to a surface of the floor of the one or more parking spaces.

12. The automatic system of claim 1, wherein the pipelines are fixable slightly below a surface of the floor of the one or more parking spaces.
